(19) United States
(12) Patent Application Publication
(10) Pub. No.: US 2006/0219307 A1
(43) Pub. Date: Oct. 5, 2006

(54) Micromixer apparatus and method therefor

(75) Inventors: An-Bang Wang, Taipei City (TW); Zdenek Travnicek, Prague (CZ); Chun-Hsien Lee, Taipei City (TW); Yi-Hua Wang, Taipei City (TW); Ming-Chang Hsu, Taipei City (TW); Chih-Kung Lee, Taipei City (TW); Alexander I. Fedorchenko, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: National Taiwan University, Taipei City (TW)

(21) Appl. No.: 11/095,075

(22) Filed: Mar. 31, 2005

(51) Int. Cl. F15C 1/20

(52) U.S. Cl. 137/824

(57) ABSTRACT

A micromixer used for microfluidic system is provided. The micromixer incorporates a pairs of reciprocating pumps and a pairs of fluidic element for mixing at least two fluids. With such a microfluid mixer, the at least two fluids are mixed when the reciprocating pumps are in their forward strokes by means of the impingement of two pulsation flows. The two fluids are also mixed when the reciprocating pumps are in their backward strokes by means of the generation of the vortexes, and the two fluids are also mixed by means of mass diffusion via a purposeful like-lamella-structure.

### FIELD OF THE INVENTION

The present invention relates to a mixing apparatus, and more specifically to a mixing apparatus used for microfluidic system.

### BACKGROUND OF THE INVENTION

A mixer is an apparatus for mixing at least two different fluids. With the operation of the mixer, at least two different fluids can be mixed rapidly and evenly. However, for different applications, it may be necessary to design a purposeful mixer for satisfying the specific demand, such as, precise mixing time, precise mixing temperature, precise mixing position. And this is especially important in the field of the microfluidic system. As the rapid development of the microfluidic system, it is still desirable to provide a micromixer with simple structures, low power consumptions and high mixing efficiency for the microfluidic system.

In general, the microfluidic system means that the hydraulic diameters of the flow channels thereof are smaller than 500 μm, and even to the order of 10¹ μm. However, in this micro-scale, the flow regime is usually maintained in the laminar flow regime with very small Reynolds numbers 10⁰ to 10². Therefore, in the microfluidic system, the mixing mechanism is totally different from the macro-scale, and the mixing efficiency would be much worse.

In the prior arts, a method for improving the mixing efficiency of the micromixer is to apply an external force to the mixed fluids, so that the turbulent flow regime can occur in the microfluidic system. Therefore, most of the micromixers are incorporated with the active means to induce the formation of turbulent flow. One of the most popular active means is the reciprocating diaphragm micropump. A classical reciprocating diaphragm micropump consists of a sealed cavity covered by a flexible wall or diaphragm, at least a pair of input/output channels, and an actuator mounted on the diaphragm. The actuator of reciprocating micropumps is driven with various principles. According to the driving force, the reciprocating micropumps can be classified as piezoelectric type, electromagnetic type, electrodynamic type, electrostatic type, thermopneumatic type, bimetallic type, electrohydrodynamic type, shape memory material type, or pneumatic type. One of the most prevalent types is the piezoelectric diaphragm. With the operation of the actuator, the pressure of the cavity would be periodically changed. When the pressure within the cavity is higher than the pressure outside, the fluids thereof are pushed out, while the pressure within the cavity is lower than the pressure outside, the fluids outside can be drawn into the cavity. Furthermore, the one-way valves can be disposed on the input/output channels to ensure the flow direction is from the input channel to the output channel. However, it is well known that the classical valves (such as movable mechanical parts) may exist many problems, such as, wearing, clogging, or fatigue of the valves, time delay of the operations and difficulty of fabrication. Therefore, a valveless fluidic component is preferable to the microfluidic system.

On the other hand, because the flow regime occurring in the microfluidic system belongs to the laminar flow regime, the mixing mechanism is almost based on the mechanism of diffusion. Therefore, the basic idea for the mixing enhancement of the micromixer is to increase the contact interface of the mixed fluids. In the prior arts, there are several methods for increasing the contact interface of the mixed fluids, such as, by means of the generations of the vortex rings, or the generation of lamella-like structure of mixed fluids. However, these apparatuses for generating the vortex rings or lamella-like structure of mixed fluids are very complicated or difficult for mass production.

Accordingly, it is the object of the present invention to provide a micromixer with high efficiency, simple structure and low power consumption. Therefore, it can be easily duplicated or be capable of mass production. Furthermore, according to the present invention, a method for improving the mixing efficiency of the micromixer is also provided.

### SUMMARY OF THE INVENTION

It is a first aspect of the present invention to provide a novel mixing apparatus which includes a first and a second fluidic elements, a first and a second micropumps, respectively configured at each of the input of the first and second fluidic elements, and a chamber configured between the first and second fluidic elements.

Preferably, the mixing apparatus outputs a first and a second jets respectively from the first and second fluidic elements into the chamber by means of reciprocations of the first and second micropumps, so that the first and second jets collide with each other and then are mixed during forward strokes of the first and second micropumps, and parts of the mixed jets are respectively pulled back from the chamber to cause flow separation and recirculation in the first and second fluidic elements during reverse strokes of the first and second micropumps.

Preferably, the first and second micropumps are reciprocating pumps.

Preferably, the reciprocating pumps are piezoelectric diaphragm pumps.

Preferably, each of the reciprocating pumps further includes an inlet, a cavity and an actuator.

Preferably, the inlet further includes a fluid diode.

Preferably, the first and second fluidic elements are nozzle-diffusers.

Preferably, each of the nozzle-diffusers is composed of a convergent flow channel and a divergent flow channel.

Preferably, a convergent angle of the convergent flow channel is ranged from 60 to 120 degree.

Preferably, a divergent angle of the divergent flow channel is ranged from 5 to 12 degree.

Preferably, each of the first and second fluidic elements further includes a fluid diode.

It is a second aspect of the present invention to provide a method for mixing at least two fluids. The method includes steps of providing a fluidic system including at least a reciprocating pump, at least a fluidic element and a chamber, supplying a first fluid in the chamber, and transporting a second fluid through the fluidic element into the chamber via the reciprocating pump to form a pulsation jet entering the chamber.

Preferably, parts of the pulsation jet and the first fluid are pulled back from the chamber to cause flow separation and recirculation in the fluidic element during the reverse stroke of the reciprocating pump.

It is a third aspect of the present invention to provide a method for mixing at least two fluids in a mixing apparatus having a pair of reciprocating pumps, a pair of fluidic elements and a chamber. The method including steps of supplying a first and a second fluids into the pair of reciprocating pumps, respectively, and transporting the first and second fluids into the chamber via the pair of reciprocating pumps to form a first and a second jets entering the chamber and then colliding with each other, so as to form a collision jet in the chamber.

Preferably, the first and second jets are in-phase jets, so that the first and second jets are mixed by means of a formation of the collision jet in the chamber.

Preferably, the frequencies and amplitudes of the first and second jets are controlled by the pair of reciprocating pumps.

Preferably, the mixing efficiency of the collision jet is enhanced by coordinating the frequencies of the first and second fluids with nature frequency of the collision jet.

Preferably, the method further includes a step of forming flow separation and recirculation in the pair of fluidic elements during the reverse strokes of the pair of reciprocating pumps.

Preferably, the first and second jets are anti-phase jets to enhance the mixing efficiency of the first and second fluids.

Preferably, the method further includes a fine mixing step by means of mass diffusion.

Preferably, the frequencies and amplitudes of the first and second jets are regulated to form a lamella-like structure of the first and second jets, so as to enhance the mixing efficiency of the first and second fluids.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram of a micromixer according to the first preferred embodiment of the present invention;

FIG. 2 (A) is a top view diagram of a micropump in accordance with the preferred embodiment of the present invention;

FIG. 2 (B) is a side view diagram of a micropump in the FIG. 2 (A) in accordance with the preferred embodiment of the present invention;

FIG. 3 (A) is a schematic diagram of a fluidic element with a forward jet during the forward stroke of the micropump in accordance with the preferred embodiment of the present invention;

FIG. 3 (B) is a schematic diagram of a fluidic element with a reverse jet during the reverse stroke of the micropump in accordance with the preferred embodiment of the present invention;

FIG. 4 (A) is a schematic diagram of the resultant collision jet formed by two in-phase pulsating jets during the forward strokes of the both micropumps;

FIG. 4 (B) is a schematic diagram of two separate vortexes formed by a pair of in-phase pulsating jets during the reverse strokes of the both micropumps;

FIG. 4 (C) and (D) are schematic diagrams of the enhanced vortexes formed respectively by a pair of anti-phase pulsating jets during the opposite strokes of the micropumps;

FIG. 5 is a schematic diagram of a lamella-like structure of two mixed fluids in accordance with the preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

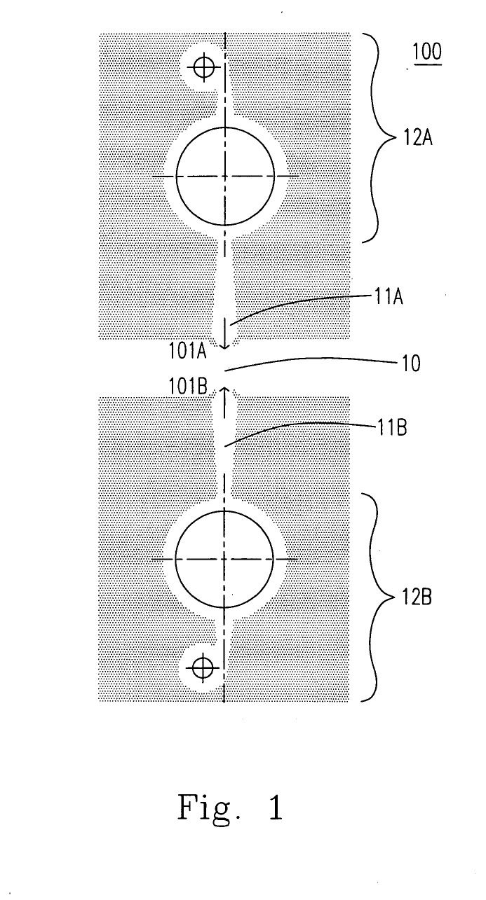

Please refer to FIG. 1, which shows a micromixer according to the first preferred embodiment of the present invention. The micromixer 100 includes a first and a second fluidic elements 11A, 11B, a mixing chamber 10 and a first and a second micropumps 12A, 12B. The first and the second micropumps are respectively configured at the inputs of the first and the second fluidic elements 11A, 11B. With the reciprocations of the first and the second micropumps 12A, 12B, a first and a second pulsation jets 101A, 101B are generated. The mixing chamber 10 is configured between the first and the second fluidic elements 11A, 11B. During the forward strokes of the first and the second micropumps 12A, 12B, the first and the second pulsation jets 101A, 101B are pushed out and transported through the first and the second fluidic elements 11A, 11B into the mixing chamber 10. While during the reverse strokes of the first and the second micropumps 12A, 12B, the preceding pulsation jets 101A, 102B, which have been mixed with each other, are respectively pulled back to the first and the second fluidic elements 11A, 11B.

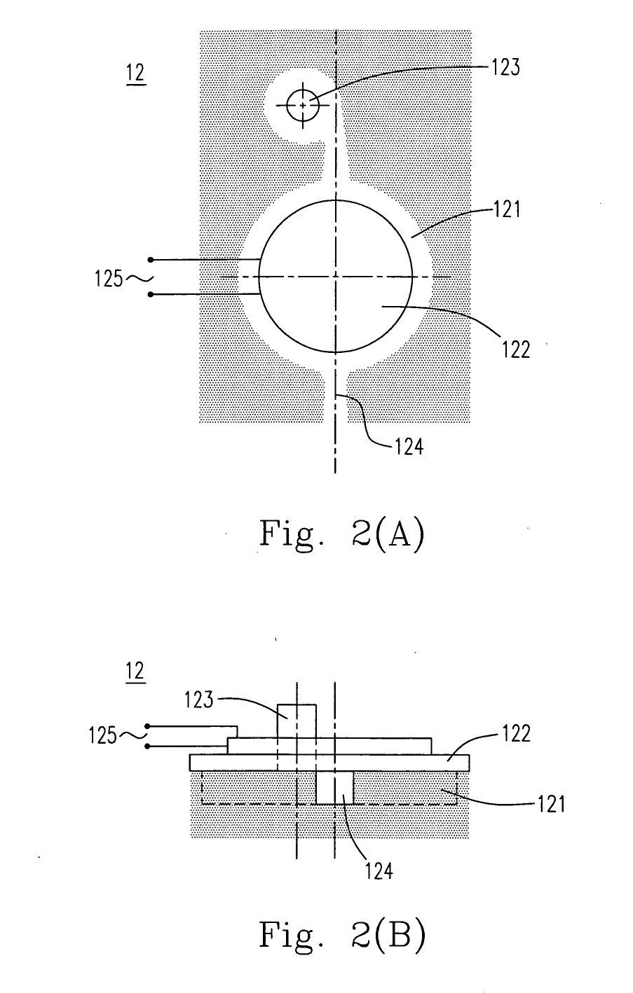

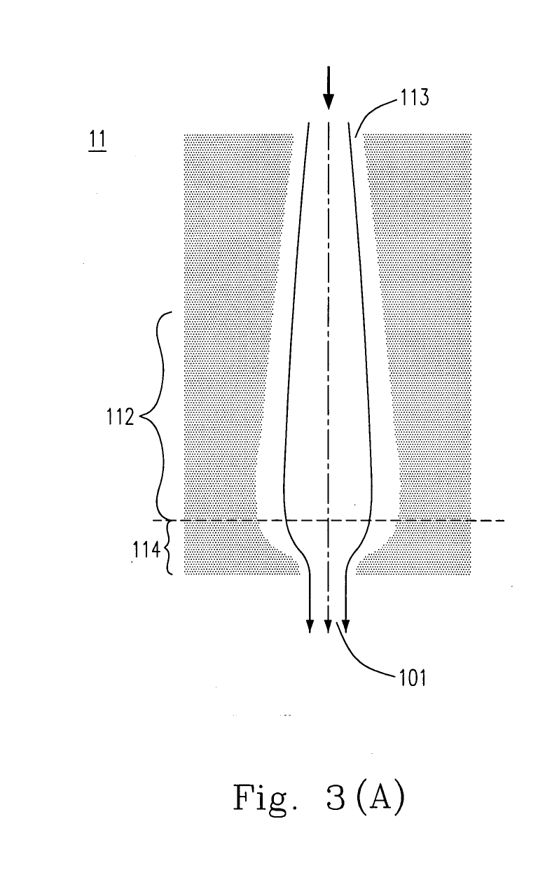

In a preferred embodiment, the first and the second micropumps 12A, 12B are reciprocating pumps, and more specifically, the pair of micropumps 12A, 12B are piezoelectric diaphragm pumps. Please refer to FIG. 2 (A) and (B), which show the top view and side diagrams of a reciprocating pump in accordance with the preferred embodiment of the present invention. The reciprocating pump includes a cavity 121, a piezoelectric diaphragm actuator 122, an input 123, and an output 124. A power source 125 is used to supply a voltage to the piezoelectric diaphragm actuator 122. With the control of the power source 125, the piezoelectric diaphragm actuator 122 is periodically oscillated, so that when the cavity 121 is compressed (forward stroke), the fluid within the cavity 121 would be pushed out and flow through the output 124, while the cavity 121 is expended (reverse stroke), a fluid is drawn from the input 123 into the cavity 121. As can be seen from the FIG. 2 (B), the flow path from the input 123 to the output 124 is cascaded, so that an intended flow direction can be obtained. In other preferred embodiment, an one-way valve or fluid diode can be disposed on the input 123 and/or output 124 to ensure the flow direction is on the way into the fluidic element.

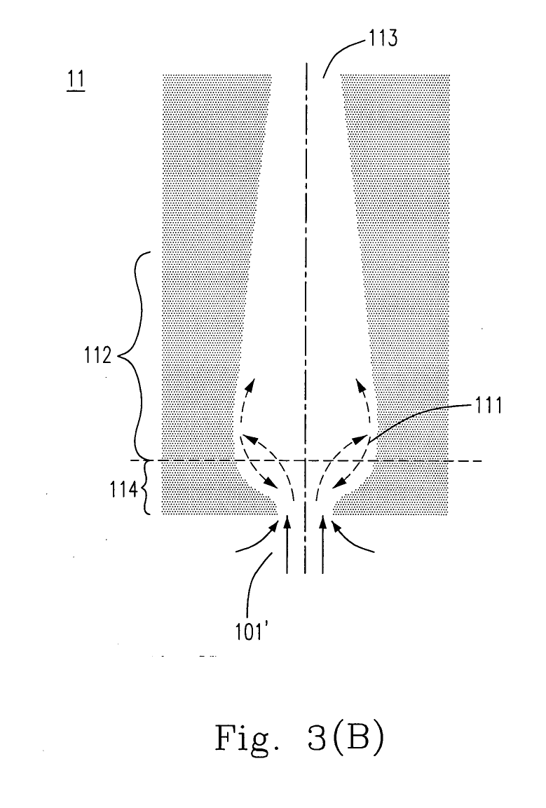

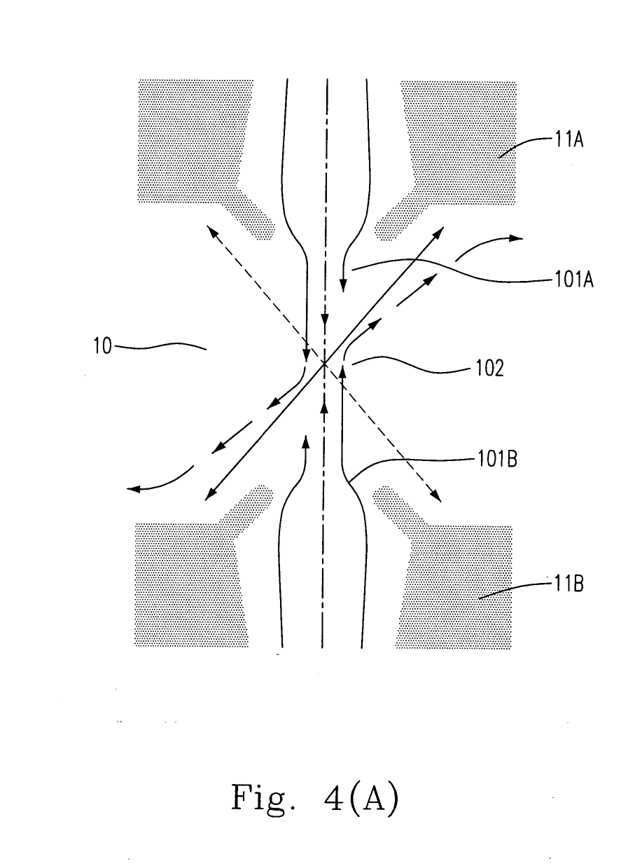

Please refer to FIG. 3(A) and (B), which show the structure of the fluidic element 11 and the formation of the pulsation jets during a forward and a reverse strokes of the micropumps in accordance with the preferred embodiment of the present invention. As can be seen from FIGS. 3(A) and (B), the fluidic element 11 includes a convergent flow channel 114 and a divergent flow channel 112. This type of fluidic element is known as a nozzle-diffuser. According to the present invention, the convergent angle of the convergent flow channel 114 is ranged from 60 to 120 degree, and the divergent angle of the divergent angle is ranged from 5 to 12 degree. In a preferred embodiment, a further one-way valve or fluid diode can be disposed on the fluidic element 11 to ensure that the flow direction is from the inlet 113 through the fluidic element into the chamber.

In a second preferable embodiment of the present invention, a method for mixing at least two different fluids in a micromixer is provided. The configuration of the micromixer, as can be seen from FIG. 1, includes at least a micropump 12A or 12B at least a fluidic element 11A or 11B and a mixing chamber 10. The method includes the following steps. First, supplying a first fluid into the mixing chamber 10. Second, transporting a second fluid through the fluidic element 11A or 11B into the mixing chamber 10 by implementing the micropump 12A or 12B, so that the second is formed as a pulsation jet 101 into the mixing chamber 10, as can be seen from FIG. 3(A). Third, during the reverse stroke of the micropump 12A or 12B, parts of the preceding pulsation jet and the first fluid in the mixing chamber 10, which forms the reverse pulsation jets (denoted as 101′ in FIG. 3(B)), are pulled back from the mixing chamber 10. Because of the rapid change of the cross section area of the fluidic element 11A or 11B, the flow separation or recirculation may occur, so that the vortex 111 is formed to enhance the mixing efficiency of the reverse pulsation jets 101′, as can be seen from FIG. 3(B).

In a third preferred embodiment of the present invention, a further method for mixing at least two different fluids in a micromixer is provided. The configuration is still similar to the micromixer shown in FIG. 1. However, the steps and strategies for implementing the pair of micropump 12A, 12B are changed. As described in the second embodiment of the invention, a fluid can be formed as a pulsation jet 101 and be transported though the fluidic element 12 into the mixing chamber 10 via the reciprocation of the micropump 12. Therefore, when a pair of micropump 12A, 12B, coupled with a pair of fluidic elements 11A, 11B, are disposed opposite to each other (as the configuration of FIG. 1), a pair of pulsation jets are injected into the mixing chamber 10 during the forward strokes of the both micropump 12A, 12B, and then collide with each other to form a collision jet 102. The formation of the collision jets 102 in the mixing chamber 10 can result in an mixing enhancement of the two fluid.

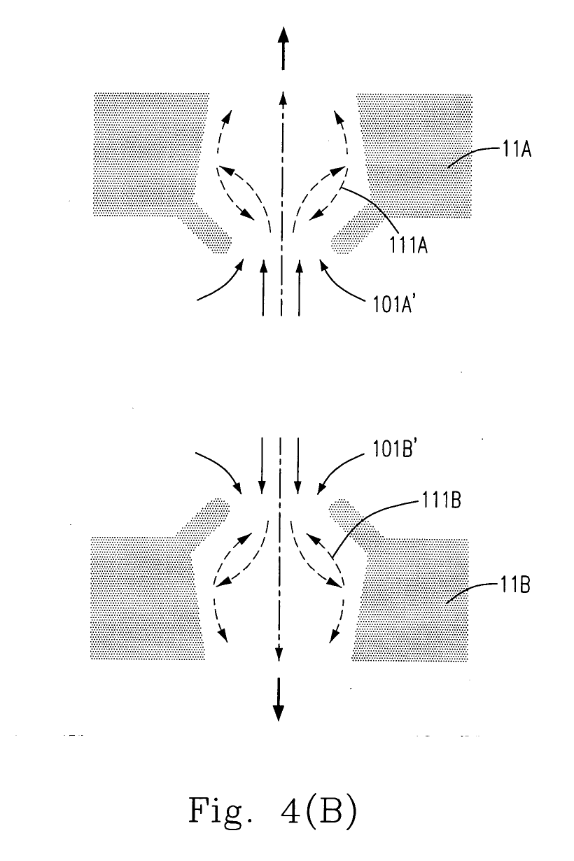

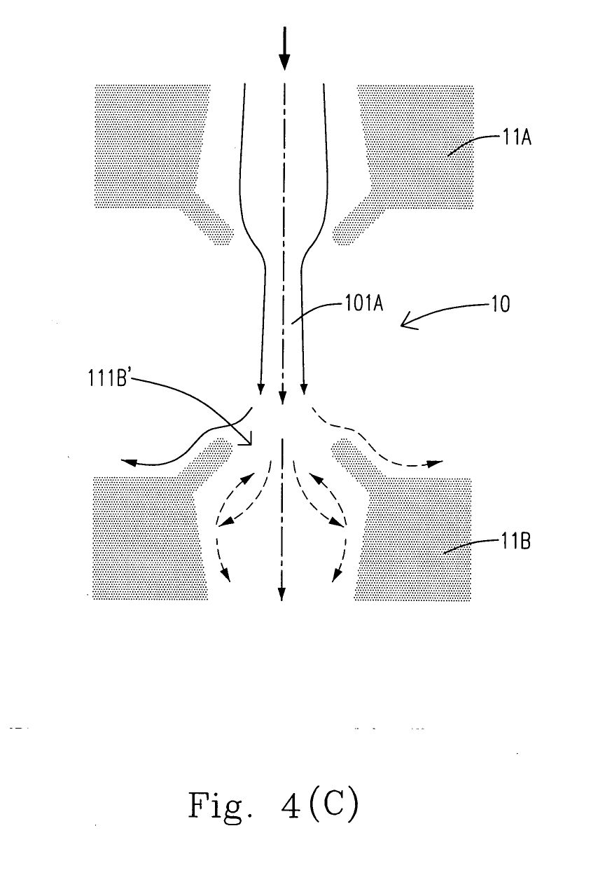

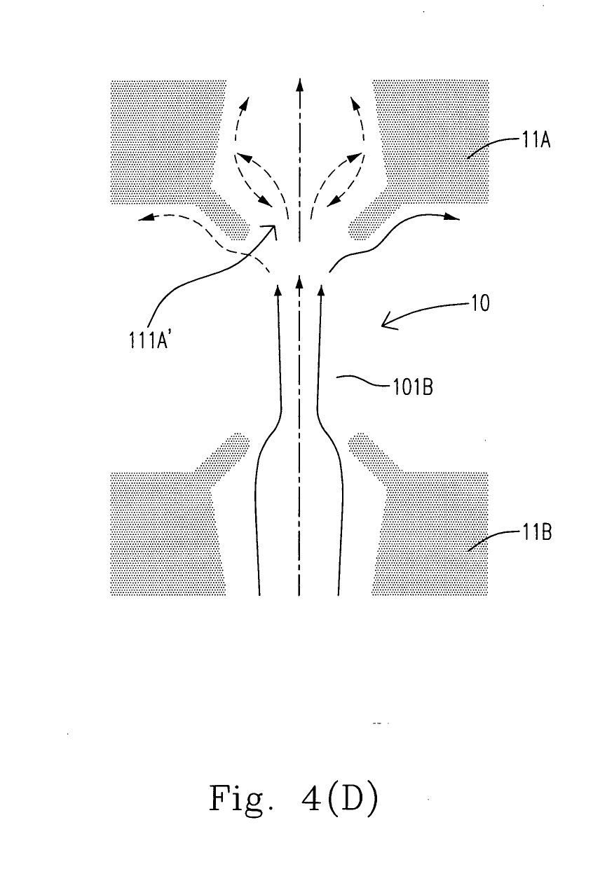

Please refer to FIG. 4(A)-(D), which show four different strategies for enhancing the mixing efficiency of the micromixer. FIG. 4(A) shows a collision of two in-phase pulsation jets 101A, 101B. The collision jet 102 formed by two in-phase pulsation jets 101A, 101B can be categorized into different patterns, such as, symmetrical, non-symmetrical (bi-stable), or flip-flop patterns. However, the mixing efficiency in all these patters can be controlled by modulating the amplitudes and frequencies of the pair of micropumps 12A, 12B. By coordinating the frequencies of the pair of pulsation jets with the nature frequency of the collision jet 102, the lock-in effect of the collision jet 102 may occur, and thus results in an enhancement of mixing efficiency of the mixed fluids.

On the other hand, FIG. 4(B) shows the formation of two vortexes in the respect fluidic elements 11A, 11B during the reverse strokes of the both micropumps 12A, 12B. This strategy used for enhancing the mixing efficiency of the micromixer is similar to the method described in the second embodiment of the present invention. However, this step can repeatedly follow the step of collision jet 102, as shown in FIG. 4 (A), and thus continuously enhancing the mixing efficiency of the mixromixer.

FIGS. 4(C) and (D) show a further strategy for enhancing the mixing efficiency of the vertex 11A or 111B, as shown in FIG. 4(B). As can be seen from FIG. 4(C), the first and second pulsation jets 101A, 101B are anti-phase jets, that is the first pulsation jet 101A is injected into the mixing chamber 10, while the reverse pulsation jets 101B′ (not shown in FIG. 4(C)) is pulled back to the fluidic element 11B. Therefore, during this process, the forward pulsation jet 101A also deliver a push power and provide more first fluid into the reverse pulsation jets 101B, so as to enhance the mixing efficiency of the vortex 111B′. FIG. 4(D) shows the reverse operations of the two anti-phase jets but similar results.

In addition to the strategies of forming the collision jets and vortexes for enhancing the mixing efficiency of the micromixer, a further strategy can be performed in the micromixer of the present invention. As described in the background of the invention, another strategy used for increasing the contact interface of mixed fluids is to form a lamella-like structure of the first and second jets, so that the contact interface between the first fluid and the second fluid can be enhanced, and thus the mixing efficiency of the first and second fluids can be enhanced.

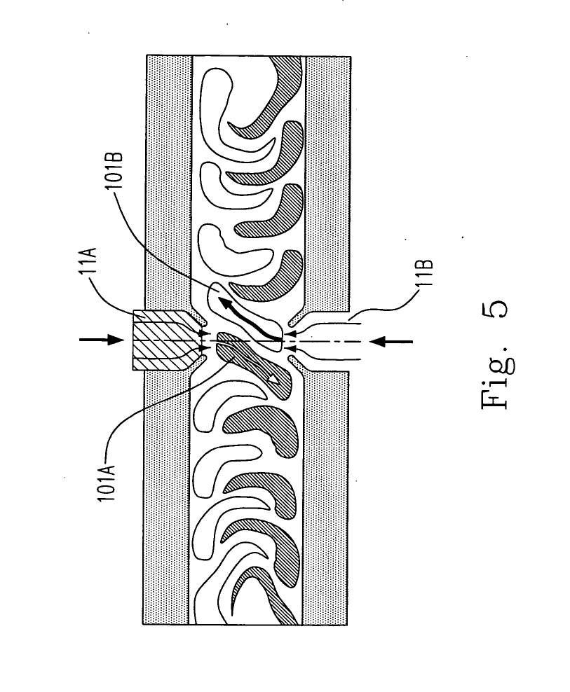

Please refer to the FIG. 5, which shows the formation of the lamella-like structure of the first and second jets 101A, 101B. The generation of the lamella-like structure are caused by the oscillation of the pair of pulsation jets 101A, 101B (and, of course, the shapes of the pair of fluidic elements 11A, 11B), and the oscillations of the pair of pulsation jets 101A, 101B are controlled by the frequencies and amplitudes of the pair of micropump 12A, 12B. Therefore, with the appropriate modulation of the frequencies and amplitudes of the pair of micropump 12A, 12B, a lamella-like structure of the first and second jets 101A, 101B can be obtained.

It should be noted that those strategies such as, the formation of a collision jet in the mixing chamber, the formation of a vortex in the fluidic element, and a formation of a lamella-like structure of the first and second jets, used for enhancing the mixing efficiency of the micromixer, can be performed step by step, so that the mixing efficiency of the micromixer can be enhanced repeatedly.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A mixing apparatus, comprising:
a first and a second fluidic elements;
a first and a second micropumps, respectively configured at each of the input of said first and second fluidic elements; and
a chamber configured between said first and second fluidic elements,
wherein said mixing apparatus outputs a first and a second jets respectively from said first and second fluidic elements into said chamber by means of reciprocations of said first and second micropumps, so that said first and second jets collide with each other and then are mixed during forward strokes of said first and second micropumps, and parts of said mixed jets are respectively pulled back from said chamber to cause flow separation and recirculation in said first and second fluidic elements during reverse strokes of said first and second micropumps.

2. The mixing apparatus according to claim 1, wherein said first and second micropumps are reciprocating pumps.

3. The mixing apparatus according to claim 2, wherein said reciprocating pumps are piezoelectric diaphragm pumps.

4. The mixing apparatus according to claim 2, wherein each of said reciprocating pumps further comprises an inlet, a cavity and an actuator.

5. The mixing apparatus according to claim 4, wherein said inlet further comprises a fluid diode.

6. The mixing apparatus according to claim 1, wherein said first and second fluidic elements are nozzle-diffusers.

7. The mixing apparatus according to claim 6, wherein each of said nozzle-diffusers is composed of a convergent flow channel and a divergent flow channel.

8. The mixing apparatus according to claim 7, wherein a convergent angle of said convergent flow channel is ranged from 60 to 120 degree.

9. The mixing apparatus according to claim 7, wherein a divergent angle of said divergent flow channel is ranged from 5 to 12 degree.

10. The mixing apparatus according to claim 1, wherein each of said first and second fluidic elements further comprises a fluid diode.

11. A method for mixing fluids, comprising steps of:
providing a fluidic system comprising at least a reciprocating pump, at least a fluidic element and a chamber;
supplying a first fluid in said chamber; and
transporting a second fluid through said fluidic element into said chamber via said reciprocating pump to form a pulsation jet entering said chamber,
wherein parts of said pulsation jet and said first fluid are pulled back from said chamber to cause flow separation and recirculation in said fluidic element during the reverse stroke of said reciprocating pump.

12. A method for mixing at least two fluids in a mixing apparatus having a pair of reciprocating pumps, a pair of fluidic elements and a chamber, comprising steps of:
supplying a first and a second fluids into said pair of reciprocating pumps, respectively; and
transporting said first and second fluids into said chamber via said pair of reciprocating pumps to form a first and a second jets entering said chamber and then colliding with each other, so as to form a collision jet in said chamber.

13. The method according to claim 12, wherein said first and second jets are in-phase jets, so that said first and second jets are mixed by means of a formation of said collision jet in said chamber.

14. The method according to claim 12, wherein the frequencies and amplitudes of said first and second jets are controlled by said pair of reciprocating pumps.

15. The method according to claim 12, wherein the mixing efficiency of said collision jet is enhanced by coordinating the frequencies of said first and second fluids with nature frequency of said collision jet.

16. The method according to claim 12, further comprising a step of forming flow separation and recirculation in said pair of fluidic elements during the reverse strokes of said pair of reciprocating pumps.

17. The method according to claim 16, wherein said first and second jets are anti-phase jets to enhance the mixing efficiency of said first and second fluids.

18. The method according to claim 12, further comprising a fine mixing step by means of mass diffusion.

19. The method according to claim 18, wherein the frequencies and amplitudes of said first and second jets are regulated to form a lamella-like structure of said first and second jets, so as to enhance the mixing efficiency of said first and second fluids.
